(19) United States
(12) Patent Application Publication
(10) Pub. No.: US 2007/0053430 A1
(43) Pub. Date: Mar. 8, 2007

(54) Image encoding device and method

(75) Inventors: Takahiko Tahira, Kawasaki (JP); Tatsushi Otsuka, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/594,081

(22) Filed: Nov. 8, 2006

Related U.S. Application Data
(63) Continuation of application No. PCT/JP04/08610, filed on Jun. 18, 2004.

(51) Int. Cl. H04N 11/04

(52) U.S. Cl. 375/240.04

(57) ABSTRACT

An image encoding device for encoding the image data of one screen composed of a plurality of image slices that each correspond to pixels in horizontal arrays on the screen, comprising: a slice data selection unit for selecting the image data of a plurality of slices constituting the one screen in a specified slice order; and an encoded slice data output unit for outputting the data of the plurality of selected and encoded image slices to the outside in an order corresponding to the specified order but in a slice order different from the specified order.

### CROSS-REFERENCE TO RELATED APPLICATIONS

This application is a continuation of international PCT application No. PCT/JP2004/008610 filed on Jun. 18, 2004.

### BACKGROUND OF THE INVENTION

1. Field of the Invention

The present invention relates to an image data encoding method, and more particularly relates to an image encoding device for encoding an image slice first (i.e., before other slices are encoded) that is located at an important position in an MPEG image (picture). The importance of a position is determined on the basis of its characteristics in relation to human viewing tendencies. As a result, this method and device is capable of reducing the deterioration of image quality even when the allocated amount of encoding information is insufficient.

2. Description of the Related Art

The MPEG encoding method is widely used as a highly efficient video signal encoding method applicable to many fields, including computers, communications, broadcasting, home information appliances, entertainment and the like.

In the MPEG encoding method, input image (picture) signals are encoded and compressed, then the bit streams after compression are output externally and stored in a DVD, an HDD or the like. In such an image encoding device, a group of horizontal slices that in total constitute a screen, is encoded.

FIG. 1 shows the encoding order of the conventional MPEG image encoding device. As shown in FIG. 1, one screen is divided into, for example, ten slices composed of a plurality of lines of horizontal pixels and each slice is encoded. This encoding is conventionally performed from the top of the screen to the bottom, in, for example, ascending slice number order, and generated bit streams are also output in ascending slice number order.

FIG. 2 shows the configuration of the conventional encoding device using such an encoding method. In FIG. 2, video signals input into an encoding device are encoded for each slice by the slice encoding unit 2 and the encoded data is temporarily stored in, for example, an encoded stream buffer 3 in the order in which it was encoded. After the encoding of one screen finishes, the encoded data in the encoded stream buffer 3 is read and is output from a stream output unit 4 as bit streams corresponding to the bit rate to be output externally. Each slice includes a start code and encoding is performed for each slice.

FIG. 3 shows the problems of the conventional encoding method. In the conventional encoding method described in FIGS. 1 and 2, encoding is sequentially performed for each slice from the top to the bottom. Therefore, when the control of the amount of information (specifically, the allocation of the encoded information amount at the time of encoding image containing a large portion of high spatial frequency components, for example) fails, the amount of information to be allocated to slices located at the bottom of the screen becomes insufficient and there is a possibility that image quality may deteriorate across the entire area of the bottom of the screen. In FIG. 3, when the position of a slice is lowered (specifically, when the vertical axis value decreases), the available amount of information becomes exhausted, an insufficient amount of information is allocated to each slice, and image quality deteriorates at the bottom of the screen. The total amount of information of one screen is almost determined by the bit rate, and encoding is performed within the range of the total amount of information.

Next, there is conventionally an image multi-encoding system in which two encoding devices are operated in parallel, video signals corresponding to one screen are divided into two areas, and each encoding device processes one of them. FIG. 4 shows such a conventional image slice multi-encoding system.

In FIG. 4, if it is assumed that a plurality of slices on the screen are divided into top-side slices and bottom-side slices and that two encoding devices A and B encode the slices for each slice, then encoding device A sequentially encodes slices from the top of the screen to the center and encoding device B sequentially encodes slices from the center of the screen to the bottom.

In such an image multi-encoding system, a slice on the boundary of the two divided areas is the last slice to be encoded of encoding device A and the first slice to be encoded of encoding device B. Therefore, if the allocated amount of information for the last slice to be encoded becomes insufficient in the same way as in FIG. 3, there is a possibility that a great difference may occur in the quality of the image data of the center boundary slice between encoding devices A and B. When such a difference occurs, a linear deterioration of image quality occurs on the boundary of the screen, which is a problem.

The following reference literature is the prior art for the above-described image encoding and transfer. Patent reference 1: Japanese Patent Application Publication No. H7-203431, “Image Processing Device and Method” Patent reference 2: Japanese Patent Application Publication No. H8-242445, “Encoding Method and Transmission Method of Image Signal, and its Decoding Device”

Patent reference 1 discloses an image processing method in which an image is divided into a simple two-by-two grid with four roughly equal sized boxes, the transfer order of the pixels in each divided image is calculated, and an outline of the image can be obtained on the receiving side by taking out one set of pixel data from each of the four images and transferring it even when the full image data cannot be transferred.

Patent reference 2 discloses an image signal encoding method for controlling the number of macroblocks allocated to each slice layer in MPEG video encoding depending on whether the image is a still image or a moving image.

However, even in such prior art, if the amount of information to be allocated to a given position (for example, a slice in an area that a user is focusing his/her attention on) becomes insufficient, the problem of the image quality deteriorating in the area being focused on cannot be solved.

### SUMMARY OF THE INVENTION

It is an object of the present invention to provide an image encoding device capable of suppressing the deterioration of image quality in a given position (more particularly, in an area likely to be focused on by a user) and a method thereof in order to solve the above-described problems.

The image encoding device of the present invention encodes the image data of one screen, which is composed of a plurality of slices that each correspond to a horizontal array of pixels on the screen. At the least, the image encoding device comprises a slice data selection unit and an encoded slice data output unit.

The slice data selection unit selects, in a specified order, the image data of a plurality of slices constituting the image data of one screen. The encoded slice data output unit outputs the image data of the plurality of encoded slices externally in an order corresponding to the specified order but in a slice order different from it.

The image encoding method of the present invention encodes image data that constitutes one screen; one screen is composed of a plurality of slices that each correspond to a horizontal array of pixels on the screen. The image encoding method comprises the selection, in a specified slice order, of the image data of a plurality of slices that constitute the image data of one screen and the outputting of the plurality of pieces of selected and encoded image slice data externally in an order corresponding to the specified order but in a slice order different from it.

Next, the image multi-encoding system of the present invention has two image encoding devices in which one screen is divided into an upper and a lower area and each image encoding device encodes the image data of one of the two areas. In the image multi-encoding system, each image encoding device sequentially selects the image slice data, with the image data of the two areas oriented in reverse of each other, in such a way that a slice on the boundary of the two divided areas and that is included in both can be selected first and priority can be given to the image data of a slice close to the boundary slice. Each image encoding device then encodes the image data.

As described above, according to the present invention, the plurality of pieces of image slice data is sequentially selected and encoded for each slice in such a way that, of a plurality of pieces of image data of a plurality of slices constituting one screen for example, the image data of an area being focused on by a user may be selected first and priority be given to the image data of slices close to the area being focused on. When the image data is output externally after the encoding, the output order of the image slice data is based on the external output method being utilized, such as the MPEG method.

### BRIEF DESCRIPTION OF THE DRAWINGS

FIG. 1 shows the slice encoding order of the conventional image encoding device;

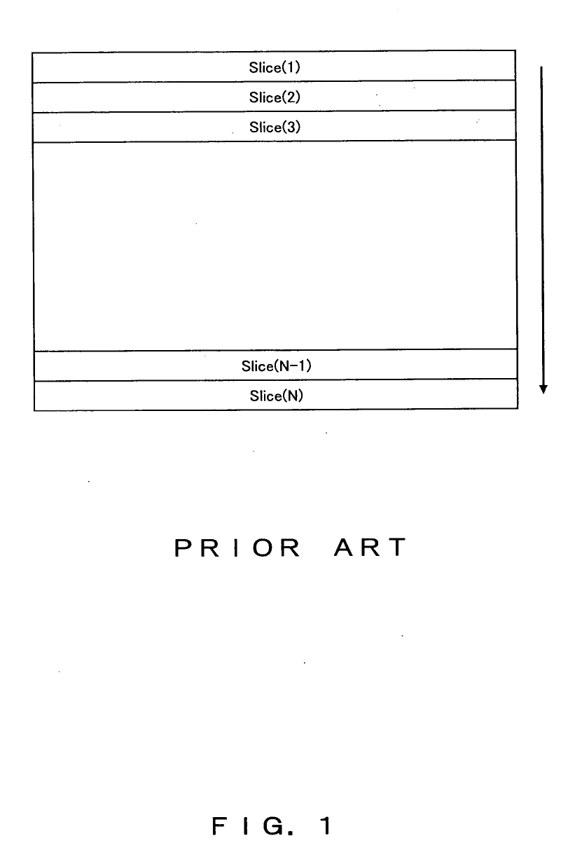

FIG. 2 shows the configuration of the conventional encoding device;

FIG. 3 shows the problems of the conventional encoding method;

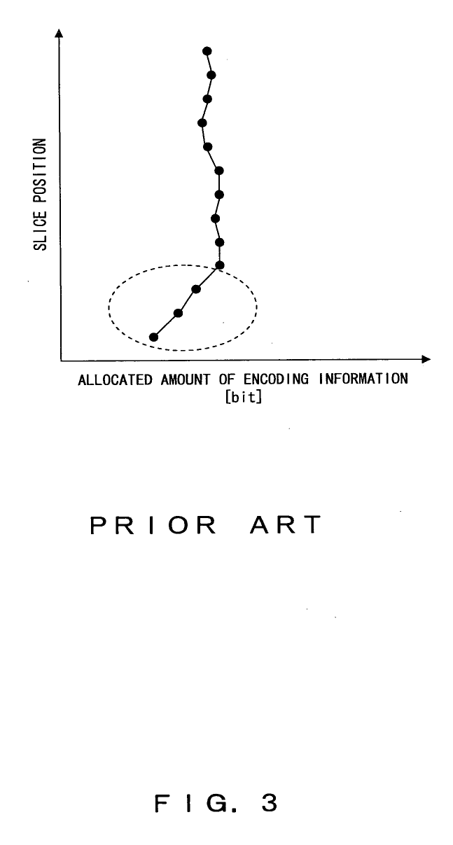

FIG. 4 shows the slice selection order of the conventional image multi-encoding system;

FIG. 5 shows the basic configuration of the image encoding device of the present invention;

FIG. 6 shows the configuration of the first preferred embodiment of the image encoding device of the present invention;

FIG. 7 shows the slice encoding order in the first preferred embodiment;

FIG. 8 shows the amount of encoding information allocated to each slice in the first preferred embodiment;

FIG. 9 shows the configuration of the second preferred embodiment of the image encoding device;

FIG. 10 shows the slice encoding order in the second preferred embodiment;

FIG. 11 is a flowchart of the entire process of the video analysis unit in the second preferred embodiment;

FIG. 12 is a flowchart of the macroblock process shown in FIG. 11;

FIG. 13 shows the slice order rearrangement in the second preferred embodiment (No. 1);

FIG. 14 shows the slice order rearrangement in the second preferred embodiment (No. 2);

FIG. 15 shows the slice encoding order in the second preferred embodiment when there is a plurality of areas likely to be focused on;

FIG. 16 shows the configuration of the preferred embodiment of the image multi-encoding system of the present invention;

FIG. 17 shows the slice encoding order in the image multi-encoding system shown in FIG. 16;

FIG. 18 shows the configuration of another preferred embodiment of the image multi-encoding system;

FIG. 19 shows the slice encoding order in the image multi-encoding system shown in FIG. 18; and

FIG. 20 shows how to load onto a computer a program for realizing the present invention.

### DESCRIPTION OF THE PREFERRED EMBODIMENTS

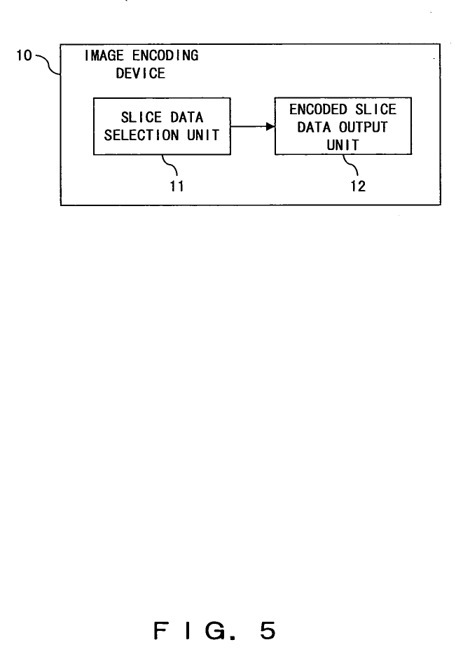

FIG. 5 shows the basic configuration of the image encoding device of the present invention. This image encoding device 10 encodes image data constituting one screen; one screen is composed of a plurality of slices, each of which correspond to a horizontal array of pixels on the screen. At the least, the image encoding device 10 comprises a slice data selection unit 11 and an encoded slice data output unit 12.

The slice data selection unit 11 selects the image data of a plurality of slices constituting the image data of one screen in a specified slice order. The encoded slice data output unit 12 outputs the data of the plurality of selected and encoded slices externally in an order corresponding to the specified order but in a slice order different from it.

The image encoding device 10 of the present invention further comprises a selection order instruction unit for specifying the slice selection order of image data in relation to a mode signal given externally. The selection order instruction unit can also specify the selection order in such a way that the image data of a slice at the center of the screen may be selected first and then priority given to the image data of a slice close to the center slice.

The image encoding device 10 can also further comprise a selection order instruction unit for analyzing input image data, detecting the area being focused on of the input image data, and specifying the selection order of a slice in such a way that the image data of a slice corresponding to the area being focused on can be selected first and then priority given to the image data of slices close to the area being focused on. Alternatively, this selection order instruction unit can detect a plurality of areas being focused on as the area being focused on and specify the selection order of the alternate encoding of image data in a plurality of surrounding image areas around the plurality of areas being focused on, including each of the plurality of areas being focused on, in such a way that for any one particular surrounding area, the image data of slices corresponding to the area being focused on may be selected first and then priority may be given to the image data of slices close to the area being focused on. Furthermore, the selection order instruction unit can also detect areas that are the color of the human body, areas that contain a mobile object image, or areas that contain many pieces of image data with a low/intermediate frequency as the area being focused on.

Next, the image multi-encoding system of the present invention has two image encoding devices in which one screen is divided into an upper and a lower area and each image encoding device encodes the image data of one of the two areas. In the image multi-encoding system, each image encoding device sequentially selects the image data of a slice in a direction the reversal of each other in such a way that a slice that is on the boundary of the two areas and is included in both areas may be selected first and priority may be given to the image data of a slice close to the boundary slice. Each image encoding device then encodes the image data.

Furthermore, the image encoding method of the present invention encodes image data constituting one screen that is composed of a plurality of slices with each slice corresponding to a horizontal array of pixels on the screen. The image encoding method comprises selecting the image data of a plurality of slices constituting the image data of one screen in a specified order and outputting the plurality of pieces of selected and encoded image slice data externally in a slice order corresponding to the specified order but in the slice order different from it.

In the present invention, a program for enabling a computer to realize this image encoding method and a computer-readable portable storage medium on which the program is recorded are used.

The preferred embodiments of the present invention are described in more detail below with reference to the drawings.

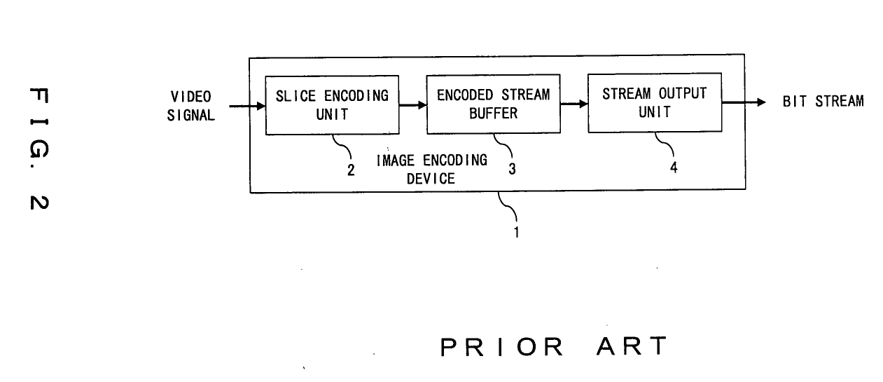

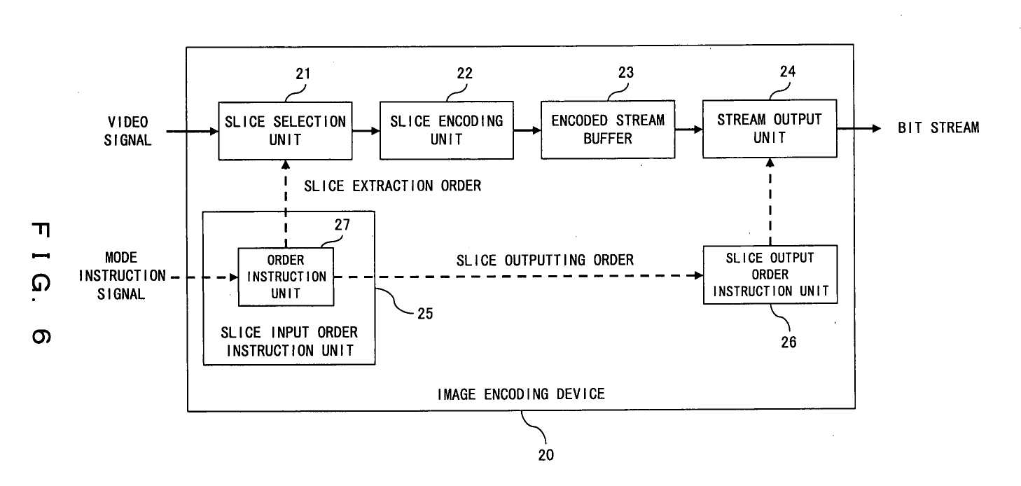

FIG. 6 shows the configuration of the first preferred embodiment of the image encoding device of the present invention. Comparing it with the conventional image encoding device shown in FIG. 2, the image encoding device comprises the following additional parts: a slice selection unit 21, a slice input order instruction unit 25, and a slice output order instruction unit 26. In addition, the image encoding device contains a slice encoding unit 22, an encoded stream buffer 23 and a stream output unit 24, all of which correspond to parts shown in FIG. 2. The slice input order instruction unit 25 comprises an order instruction unit 27.

In the first preferred embodiment, the configuration of which is shown in FIG. 6, it is assumed that the selection order of a slice is determined in relation to a mode specification signal given externally to the image encoding device 20 and that image slice data is encoded. In this first preferred embodiment, image data is encoded by the specification of this mode specification signal in such a way that a slice at the center of the screen can be selected first and priority can be given to slices close to the center slice. This is because in this preferred embodiment, in order to prevent the deterioration of the image quality of an area on the screen to which a user is paying attention, image data is encoded in such a way that the area being focused on slice is selected with top priority and then priority may be given to slices close to the slice of the area being focused on. In the first preferred embodiment, the image data of the slice at the center of the screen is encoded first because users tend to pay attention to the area around the center of the screen.

The slice data selection unit set forth in claim 1 of the present invention corresponds to the slice selection unit 21 shown in FIG. 6. The encoded slice data output unit set forth in claim 1 corresponds to the slice output order instruction unit 26 and stream output unit 24 shown in FIG. 6. The selection order instruction unit set forth in claim 2 corresponds to the order instruction unit 27 shown in FIG. 6.

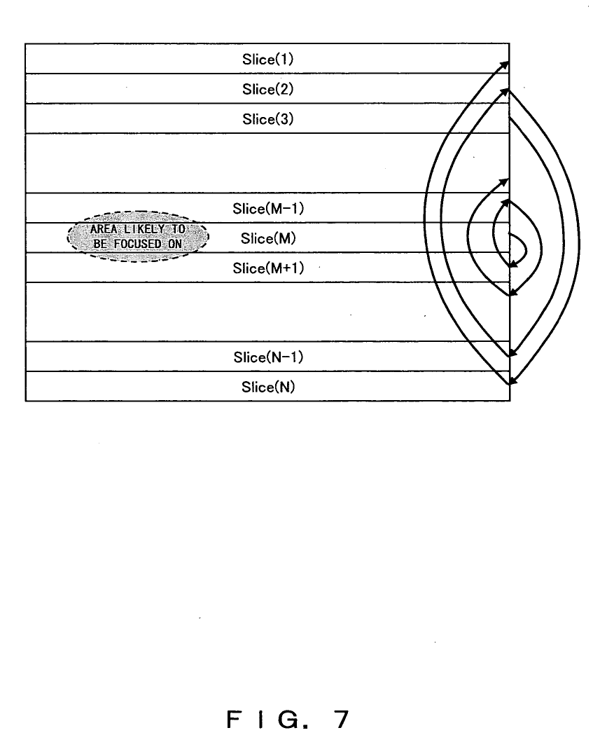

FIG. 7 shows the slice encoding order in which the image data of a slice in the area being focused on at the center of the screen is selected first and the image data of slices close to the area being focused on are encoded with priority. In FIG. 7, the image data of a slice included in the area being focused on or that of a slice close to it, specifically the M-th slice in this case, is encoded first, then that of the slice below it, that is, the (M+1)th slice, is encoded and then that of the (M−1)th slice is encoded. The image data of the slice at the top or bottom is encoded last. Note that in FIG. 7, the area being focused on appears to be biased to the left side of the screen. However, this is because the slice numbers are given around the center and there is no special meaning to the location of these labels.

Specifically, when in FIG. 6 a mode specification signal gives an instruction to the order instruction unit 27 to select a slice at the center of the screen first, the order instruction unit 27 instructs the slice selection unit 21 to select a slice at the center of the screen first and to select other slices in the order shown in FIG. 7. The slice selection unit 21 selects slices from an input image signal in a specified extraction order and gives the selected slices to the slice encoding unit 22.

The operations performed in the slice encoding unit 22 through the stream output unit 24 are essentially the same as those performed in the conventional device shown in FIG. 2. Specifically, image data encoded for each slice by the slice encoding unit 22 is temporarily stored in the encoded stream buffer 23 and is output externally as, for example, a bit stream in accordance with the bit rate to be output externally when, for example, full data for one screen is encoded.

When outputting the streams, the slice output order instruction unit 26 specifies a slice output order for the stream output unit 24, and the streams are output according to that order. A slice outputting order that is determined in relation to the slice extraction order is given from the order instruction unit 27 of the slice input order instruction unit 25 to the slice output order instruction unit 26. Then, an encoded data rearrangement order for each slice is given to the stream output unit 24 as a slice output order using the MPEG method. This data rearrangement order is given in order to rearrange the encoded slice data stored in the encoded stream buffer 23 according to the encoding order in order to sequentially output it from the top of the screen toward the bottom in ascending slice number order.

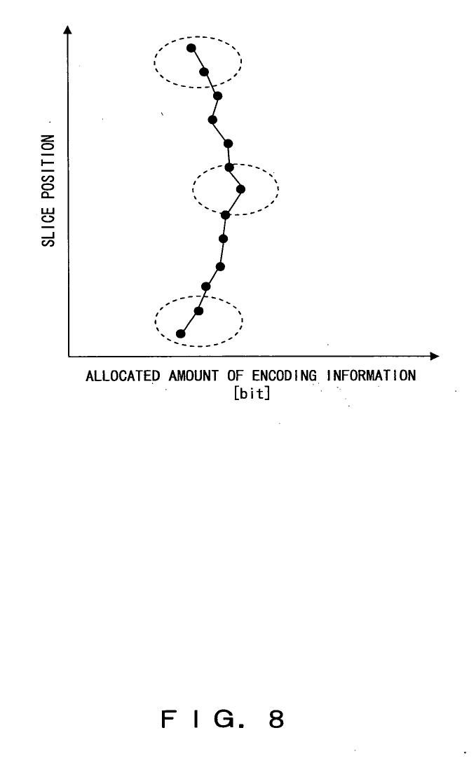

FIG. 8 shows the amount of encoding information allocated to each slice in the first preferred embodiment. In order to start encoding with the image data of a slice at the center of the screen in the area being focused on, the allocated amount of information of the slice at the center of the screen is set to be relatively large, the deterioration of the image quality at the center of the screen is minimized and the amount of information allocated to a slice at the top or bottom of the screen is reduced to be relatively small. Thus, the areas with deteriorated image quality can be restricted to areas to which users pay little attention such as the top or bottom of the screen and be dispersed while suppressing the amount of encoding information as a whole.

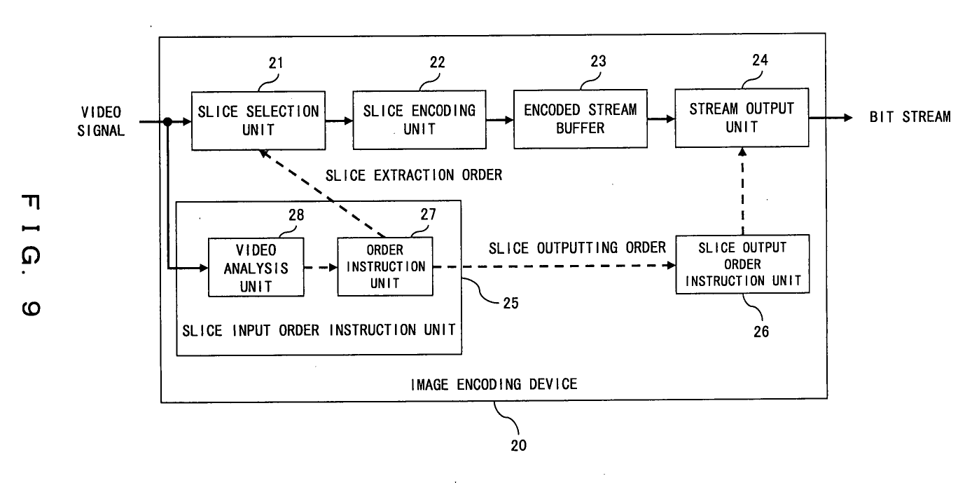

FIG. 9 shows the configuration of the second preferred embodiment of the image encoding device. While in the first preferred embodiment the slice at the center of the screen is encoded first and then the image data of slices close to the slice at the center are encoded with priority, in this second preferred embodiment image data in a given position can be encoded in any order.

Specifically, while in the first preferred embodiment the image data of the slice at the center is encoded first on the basis of the assumption that users tend to pay attention to the center of the screen, in the second preferred embodiment an area to which a user is likely to be paying attention is detected from one screen and the image data of the slice in the area being focused on is encoded first.

As an example of such an area that is likely to be focused on, an image area including the color of human skin can be detected. This is based on the fact that a person is particularly sensitive to human body color as the visual characteristic of a human being. Alternatively, an image area that includes a mobile object on the screen can be detected as the area being focused on since people tends to follow a mobile object as the visual characteristic of a human being. Or, as another example, an area including many pieces of image data that includes a low or intermediate spatial frequency can be detected as the area being focused on since the visual resolution power of a human being tends to be more sensitive to low to intermediate spatial frequency image data than to high spatial frequency image dada.

The second preferred embodiment of the image encoding device, as shown in FIG. 9, differs from the first preferred embodiment, shown in FIG. 6, in that a video analysis unit 28 for analyzing an input video signal and detecting an area being focused on is added to the slice input order instruction unit 25. In the second preferred embodiment, image data is encoded in such a way that a slice in the position of an area likely to be focused on as detected by this video analysis unit 28 may be selected first and then slices close to this position may be selected with priority. The order instruction unit 27 specifies such an encoding order as a slice extraction order for the slice selection unit 21 and also gives a slice outputting order to the slice output order instruction unit 26. Thus, in the same way as in the first preferred embodiment, the stream output unit 24 outputs the encoded image data externally as a bit stream in, for example, an order dictated by the MPEG method. The selection order instruction unit set forth in claim 4 of the present invention corresponds to the video analysis unit 28 and the order instruction unit 27 shown in FIG. 9.

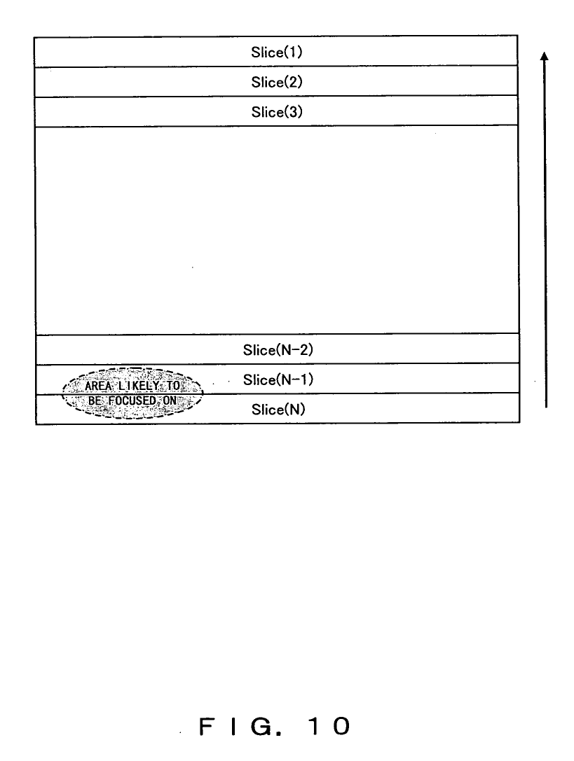

FIG. 10 shows the slice encoding order in the case in which the area being focused on is located at the bottom of the screen. In FIG. 10, since the area being focused on is located at the bottom of the screen, image data is encoded for each slice in descending slice number order starting with the slice at the bottom, that is, the Nth slice. In other words, image data is encoded from bottom to top.

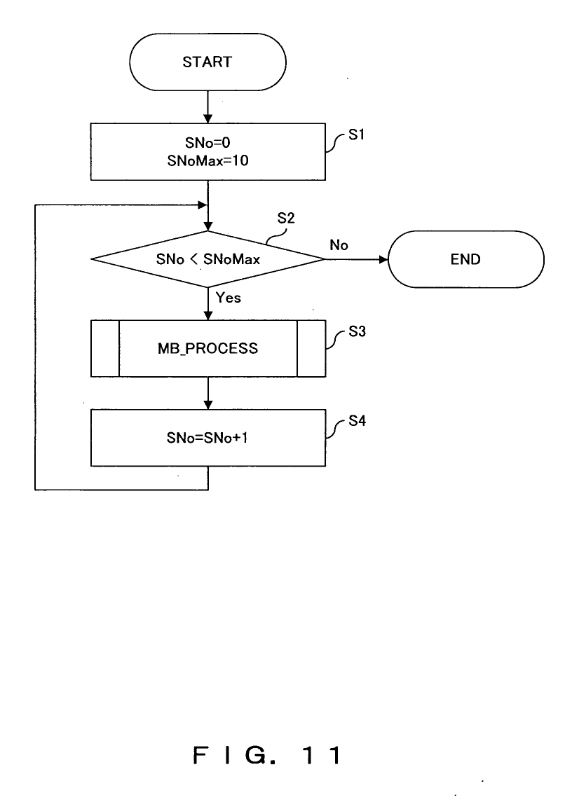

Since, as described above, the second preferred embodiment is characterized by the fact that the video analysis unit 28 detects the area being focused on the screen, the process that the video analysis unit 28 uses to detect this area being focused on and the modification of the slice selection order for encoding image data in relation to this process are described below with reference to FIGS. 11 through 14.

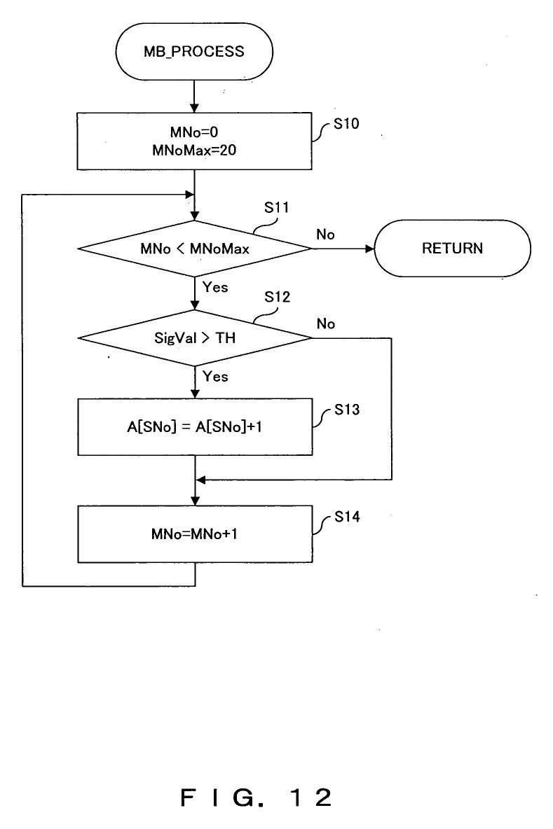

FIG. 11 is a flowchart of the entire process of the video analysis unit. In FIG. 11, the symbols SNo, SNoMax and MB represent a slice number, the highest slice number value, and a macroblock, respectively. Firstly, in step S1, it is assumed that the slice number and the highest value are 0 and 10, respectively, for this example. In step S2, it is determined that the slice number is less than the highest value. If the slice number is less than the highest value, in step S3, a macroblock process is performed. This process detects, as an evaluation value (which is described later with reference to FIG. 12), how many macroblocks there are in which the amount of the evaluation target data in a specific slice exceeds a specific threshold (for example, the number of human-body colored pixels exceeds a specific threshold). For this evaluation value, a value based on the combination of a brightness signal and a color signal (such as human body color) can be used. If a moving image area is used for the area being focused on, a value corresponding to a motion vector signal can also be used.

After the macroblock process of a specific slice, a slice with a slice number of 0 at first, finishes, the slice number is incremented in step S4, and the processes in steps S2 and after are repeated. When in step S2 the slice number is the highest value, the process terminates.

FIG. 12 is a detailed flowchart of the macroblock process in step S3 of FIG. 11. In FIG. 12, the symbols MNo, MNoMax, SigVal, TH and A[SNo] represent a macroblock number, the highest value that exists for the macroblock numbers, the value of a piece of evaluation target data, the threshold of a piece of evaluation target data, and the evaluation value of slice number SNo, respectively.

Firstly, in step S10 it is assumed that the macroblock number and the highest value are 0 and 20, respectively, for this example. In step S11 it is determined whether the macroblock number is less than the highest value. If the macroblock number is less than the highest value, it is determined in step S12 whether the evaluation target data value exceeds a threshold. If the value exceeds the threshold, the evaluation value of a slice with the current process target slice number is incremented in step S13. If the value does not exceed the threshold, the macroblock number is immediately incremented in step S14 and the processes in steps S11 and after are repeated. When in step S11 it is determined that the macroblock number is the highest value, the flow proceeds to the process in step S4 of FIG. 11.

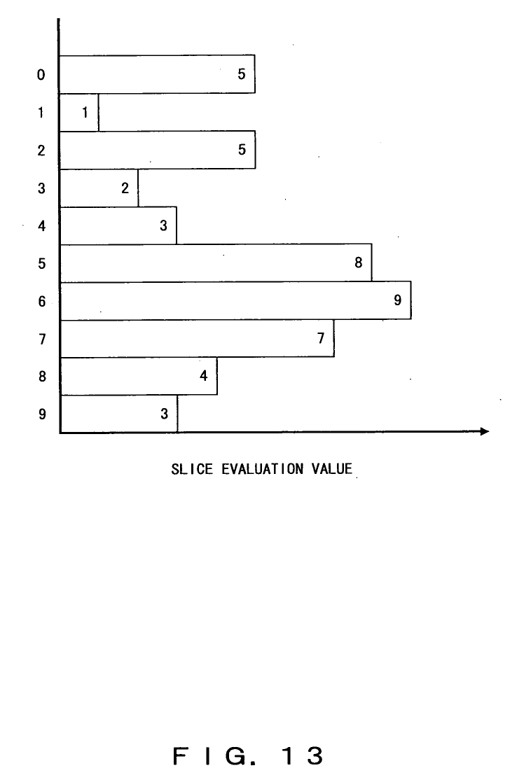

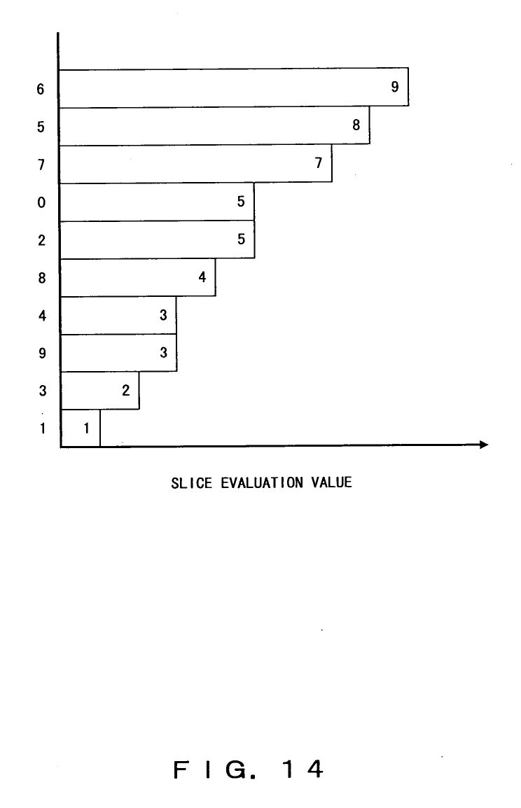

FIGS. 13 and 14 show the slice encoding order rearrangement according to the evaluation value of a slice. FIG. 13 shows the evaluation values of slice numbers 0 through 9 before the rearrangement. In this case, for example, the evaluation value of slice number 6 becomes the highest value.

FIG. 14 shows the slice encoding order rearrangement corresponding to this evaluation value. In this case, as described in FIG. 13, the evaluation value of slice number 6 is the highest, and image data corresponding to each slice is encoded in descending evaluation value order sequentially from top to bottom, as shown in FIG. 14.

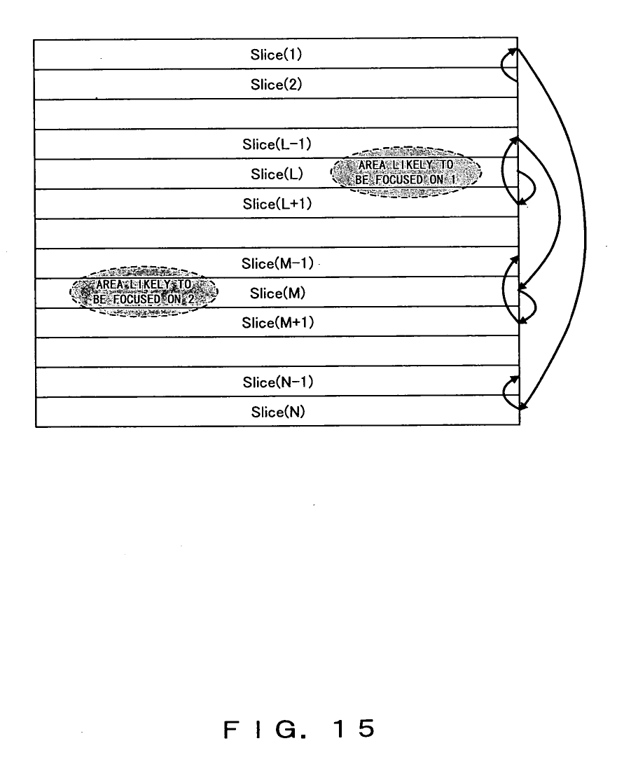

FIG. 15 shows the slice encoding order in a case in which there is a plurality of areas being focused on in the second preferred embodiment. For example, if in FIG. 13 two different slices are found to have the highest evaluation value when the evaluation values of slices are arrayed according to slice number, it is determined that there are two areas being focused on, and image data is encoded for each slice in such a way that priority may be given to slices close to each of the areas being focused on while, for example, alternating between encoding slices in area being focused on 1 (hereinafter, “area 1”) and slices in area being focused on 2 (hereinafter, “area 2”). Thus, the deterioration in the image quality of image data in slices in each area being focused on and their vicinity can be reduced.

In FIG. 15, it might be, for example, determined that area 1 has a higher priority than area 2. In this situation, by first encoding image data in the neighborhood of area 1 for each slice, then encoding image data in the neighborhood of area 2 for each slice, and lastly encoding the top and bottom slices, in that order, the area where image quality deteriorates can be restricted to the top or bottom of the screen when the amount of information is insufficient.

As described above, in the second preferred embodiment, an area being focused on is detected and image data is encoded for each slice in such a way as to give priority to slices in the area being focused on. Similarly, a preferred embodiment in which a slice encoding order is determined by giving priority to slices with a large amount of information after slice encoding can also be considered. Specifically, by encoding the image data of a slice with a large amount of encoded data with higher priority in the selection order than that of a slice with a small amount of encoded data, a shortage in the allocated amount of encoding information in a slice with a large amount of encoded data can be prevented.

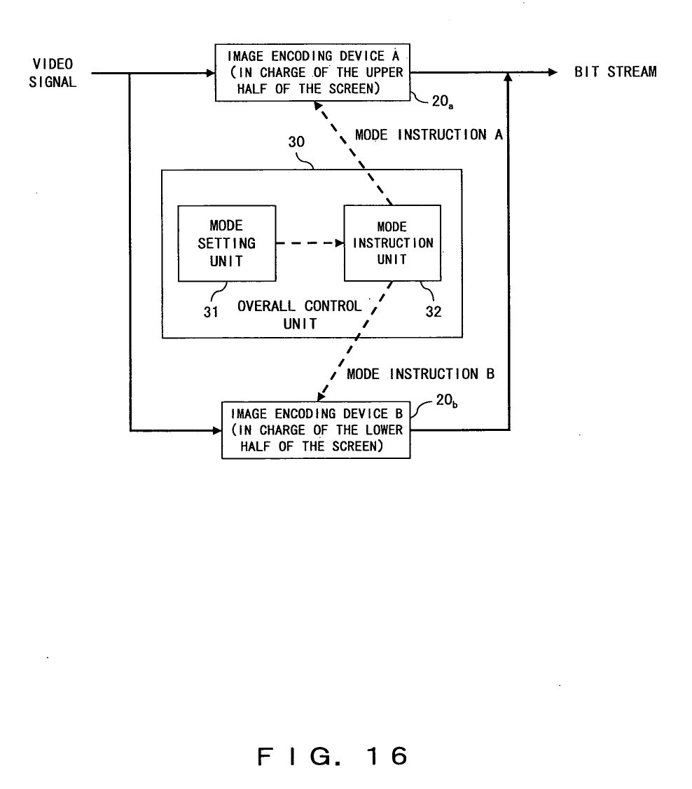

FIG. 16 shows the overall configuration of the preferred embodiment of the image multi-encoding system in this preferred embodiment. In FIG. 16, the operations of two image encoding devices 20ₐ and 20_{b} are controlled by an overall control unit 30. Each of these two image encoding devices 20ₐ and 20_{b} has the configuration of the first preferred embodiment shown in FIG. 6 and operates according to a mode instruction from the mode instruction unit 32 in the overall control unit 30. A mode setting unit 31 sets the operation mode of the mode instruction unit 32.

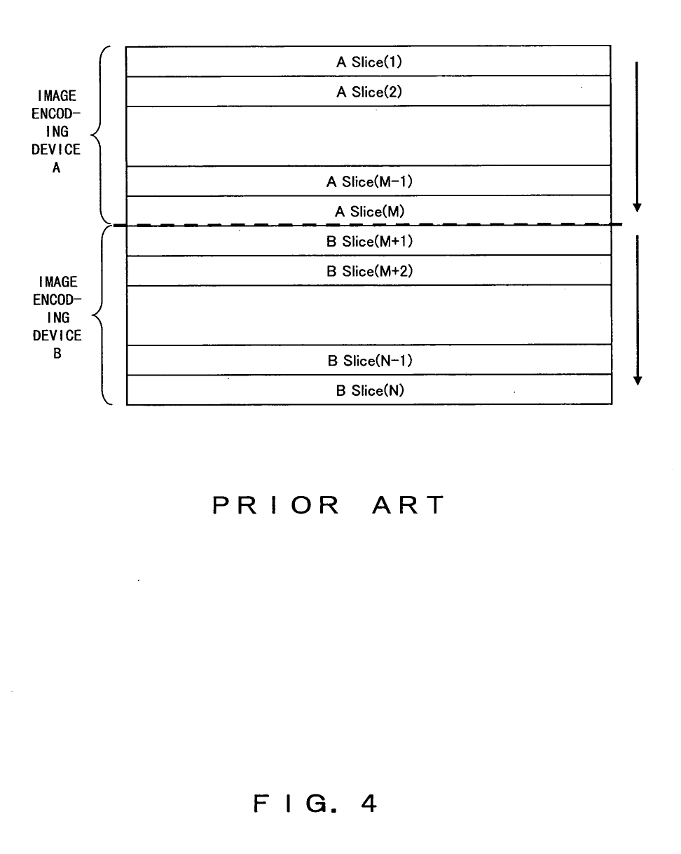

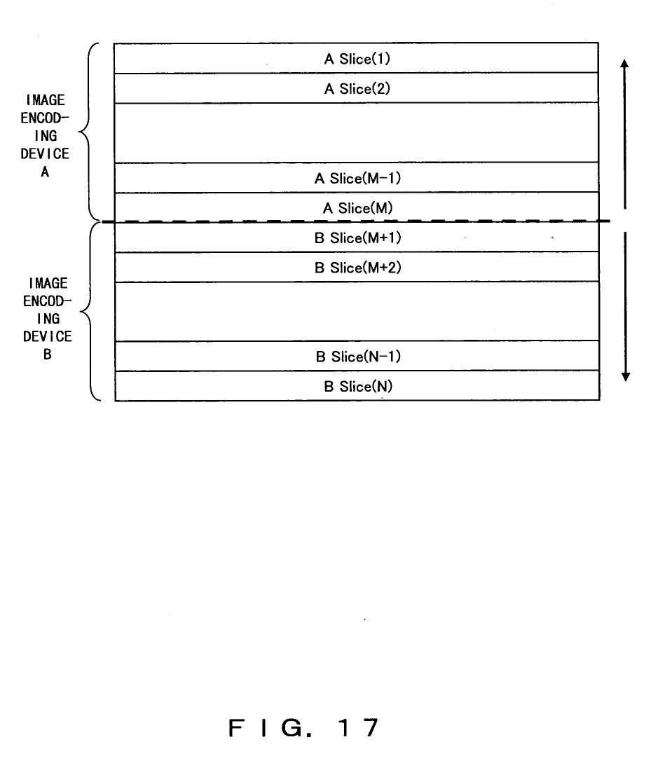

FIG. 17 shows the slice encoding order in the image multi-encoding system shown in FIG. 16. While conventionally one and the other of two image encoding devices simply encode image data for each slice from the top to the center and from the center to the bottom, respectively, in ascending slice number order according to the MPEG method as described in FIG. 4, in this preferred embodiment the image encoding device 20ₐ sequentially encodes image data by, for example, starting with a slice at the center and moving toward the top (that is, in descending slice number order) and the image encoding device 20_{b} sequentially encodes image data by, for example, starting with a slice at the center and moving toward the bottom in ascending slice number order. Thus, there would be no linear deterioration in image quality at the center of the screen, which is different from conventional devices. In addition, the starting position for encoding can be made very close. In addition, as described in FIG. 8, a sufficient amount of information can be allocated to a slice in the starting position for encoding (at the center) and thereby ensure that the image produced will be suitable for viewing by human beings, who tend to pay attention to the center of the screen.

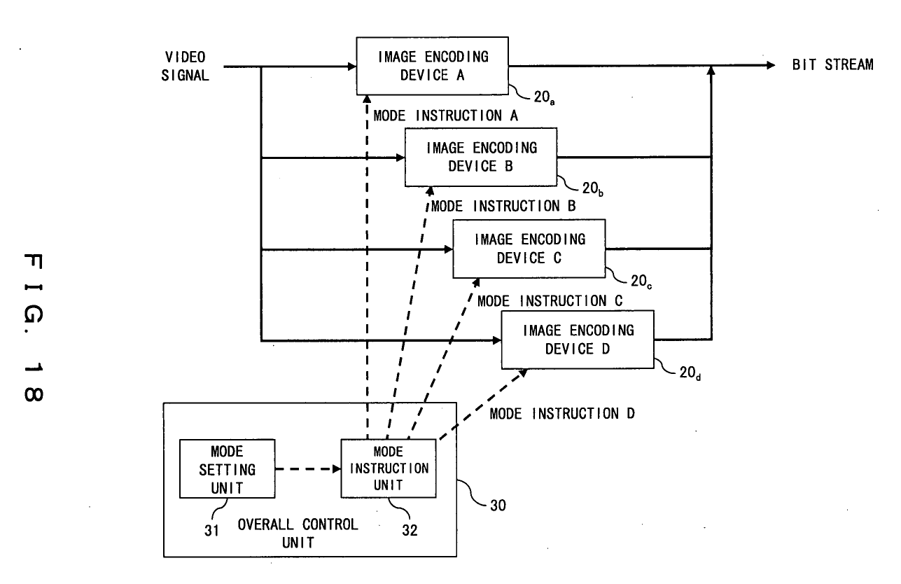

In the image multi-encoding system of this preferred embodiment, more than two image encoding devices can also be used to encode image data, as opposed to using only two image encoding devices as shown in FIG. 16. FIG. 18 shows the configuration of such an image multi-encoding system. In FIG. 18, four image encoding devices 20ₐ through 20_{d} are used; by giving mode instructions from the mode instruction unit 32 to each image encoding device in the same way as in FIG. 16, the image data of one screen can be encoded.

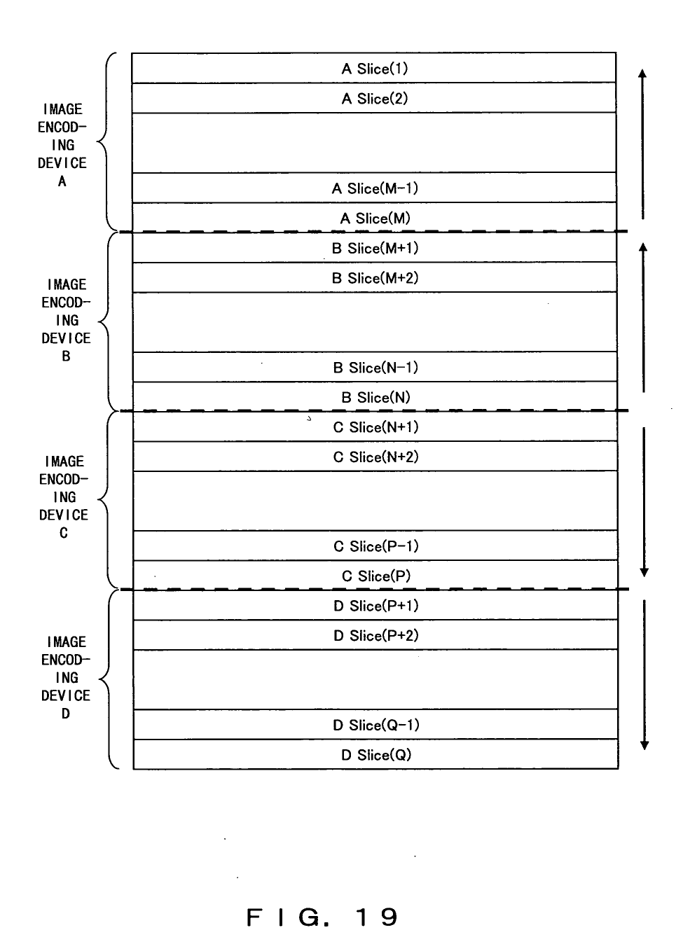

FIG. 19 shows the slice encoding order in the image multi-encoding system shown in FIG. 18. In FIG. 19, the image encoding devices 20a, 20b, 20c and 20d encode the image data of slices in each of the four divided areas from the position ¼ from the top of the screen toward the top, from the center toward the top, from the center toward the bottom and from the position ¾ from the top toward the bottom, respectively.

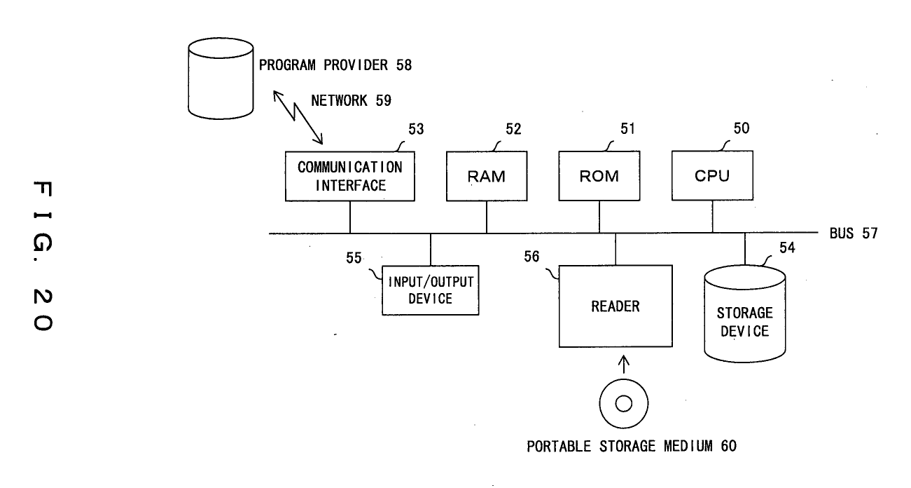

The image encoding device and its method have been described in detail; this image encoding device can be configured using a general computer system. FIG. 20 shows the configuration of such a computer system, i.e., the hardware environment.

In FIG. 20, the computer system comprises a central processing unit (CPU) 50, read-only memory (ROM) 51, random-access memory (RAM) 52, a communication interface 53, a storage device 54, an input/output device 55, a portable storage medium reader 56 and a bus 57 to which all the components are connected.

For the storage device 54, various types of storage devices such as hard disks, magnetic disks and the like can be used. The programs shown in FIGS. 11 and 12 and the program set forth in claim 9 of the present invention can be stored in such storage devices 54 or in the ROM 51. By executing such a program via the CPU 50, the areas of focus can be detected in the preferred embodiment, slice encoding can be started with slices in the area(s) of focus, and the deterioration of image quality in an image multi-encoding system can be prevented.

Such a program can be stored by a program provider 58 in, for example, the storage device 54 via a network 59 and the communication interface 53. Alternatively, the program can be stored in a marketed and distributed portable storage medium 60; the portable storage medium 60 can be set in its reader 56 and the program can be executed by the CPU 50. For the portable storage medium 60, various kinds of storage media such as CD-ROMs, flexible disks, optical disks, magneto-optical disks, DVDs, and the like can be used. Image encoding starting with slices in an area being focused on in the preferred embodiment and the like can be realized by the reader 56 reading a program stored in such a storage medium.

The present invention is applicable not only to the industry of manufacturing image encoding devices for encoding and compressing image (video) signals by using the MPEG method or the like and converting the encoded and compressed image data into bit streams, but also to all industries using such an image encoding method.

What is claimed is:

1. An image encoding device for encoding the image data of one screen composed of a plurality of image slices that each correspond to pixels in horizontal arrays on the screen, comprising:
a slice data selection unit for selecting the image data of a plurality of slices constituting the one screen in a specified slice order; and
an encoded slice data output unit for outputting the data of the plurality of selected and encoded image slices to the outside in an order corresponding to the specified order but in a slice order different from the specified order.

2. The image encoding device according to claim 1, further comprising:
a selection order instruction unit for specifying the selection order of the image slice data according to an externally given mode signal.

3. The image encoding device according to claim 2, wherein
the selection order instruction unit specifies the selection order in such a way that the image slice data at the center of a screen can be selected first and then priority can be given to image data of slices close to the slice at the center.

4. The image encoding device according to claim 1, further comprising
a selection order instruction unit for analyzing input image data, detecting an area likely to be focused on in the input image data and specifying a selection order for the image slice data in such a way that image data of a slice in the area being focused on may be first selected and then priority may be given to slices close to the area being focused on.

5. The image encoding device according to claim 4, wherein the selection order instruction unit detects a plurality of areas likely to be focused on as the area being focused on and specifies the selection order for an alternate encoding of image data among a plurality of surrounding areas around the plurality of areas being focused on, including each of the plurality of areas being focused on in such a way that, for one of the plurality of surrounding areas, image slice data corresponding to the area being focused on may be placed first in the order and priority may be given to image data of slices close to the area being focused on.

6. The image encoding device according to claim 4 or 5, wherein
the selection order instruction unit can detect areas that are the color of the human body, areas that contain a mobile object image, or areas that contain many pieces of image data with a low/intermediate spatial frequency light as the area being focused on.

7. An image multi-encoding system provided with two image encoding devices in which one screen is divided into an upper area and a lower area and each of the two image encoding devices encodes image data in one of the two areas, wherein
each of the two image encoding devices selects image slice data in a direction the reversal of each other, starting with a slice that is on the boundary of and included in both of the two divided areas, and encodes the image data.

8. An image encoding method for encoding the image data of one screen that is composed of a plurality of slices corresponding to horizontal arrays of pixels on the screen, comprising:
selecting the image data of a plurality of slices constituting the one screen in a specified slice order; and
outputting the plurality of selected and encoded image slice data to the outside in an order corresponding to the specified order but in a slice order different from the specified order.

9. A computer-readable portable storage medium on which is recorded a program for enabling a computer to encode the image data of one screen that is composed of a plurality of slices corresponding to pixels in horizontal arrays on the screen, comprising:
selecting the image data of a plurality of slices constituting the one screen in a specified slice order; and
outputting the plurality of selected and encoded image slice data externally in an order corresponding to the specified order but in a slice order different from the specified order.

10. An image encoding device for encoding the image data of one screen composed of a plurality of slices corresponding to pixels in horizontal arrays on the screen, comprising:
a selection unit for selecting a slice with a large amount of encoded data from the plurality of slices as a slice to process with a higher priority than a slice with a small amount of encoded data; and
an encoding unit for encoding image data in the slice selection order.
